(19) United States
(12) Patent Application Publication
(10) Pub. No.: US 2013/0052616 A1
(43) Pub. Date: Feb. 28, 2013

(54) METHODS AND SYSTEMS FOR DEVICE MANAGEMENT WITH SHARING AND PROGRAMMING CAPABILITIES

(71) Applicants: JASON SILVERSTEIN, HOFFMAN ESTATES, IL (US); CHRISTA LYNNE KUMINSKI, CHICAGO, IL (US); KERRY LYNNE MCALEER-FORTE, BERWYN, IL (US); JUDE S. RETER, CHICAGO, IL (US)

(72) Inventors: JASON SILVERSTEIN, HOFFMAN ESTATES, IL (US); CHRISTA LYNNE KUMINSKI, CHICAGO, IL (US); KERRY LYNNE MCALEER-FORTE, BERWYN, IL (US); ANTHONY KIM, CHICAGO, IL (US); JUDE S. RETER, CHICAGO, IL (US); UKI D. LUCAS, MUNDELEIN, IL (US)

(73) Assignee: SEARS BRANDS, L.L.C., HOFFMAN ESTATES, IL (US)

(21) Appl. No.: 13/421,499

(22) Filed: Mar. 15, 2012

Related U.S. Application Data
(60) Provisional application No. 61/453,744, filed on Mar. 17, 2011.
(60) Provisional application No. 61/453,748, filed on Mar. 17, 2011.
(60) Provisional application No. 61/453,759, filed on Mar. 17, 2011.

(51) Int. Cl. G09B 19/00

(52) U.S. Cl. 434/127

(57) ABSTRACT

A system which includes a network of appliances functions to retrieve from a data repository, such as a centralized server, at least one data set containing food preparation instructions and to control one or more operations of at least one food preparation device, such as cooking temperatures and times associated with a stove, in accordance with the retrieved at least one data set containing food preparation instructions. The retrieved data set may additional be utilized to cause one or more devices to provide voice prompts to assist a user in the performance of the corresponding food preparation task. The data sets provided for this purpose may be standardized to allow recipes to be shared and used across multiple different appliance types.

### CROSS REFERENCE TO RELATED APPLICATIONS

This application is a non-provisional application claiming priority from U.S. Provisional Application Ser. No. 61/453,744, filed Mar. 17, 2011, entitled “Recipe Management Application With Wireless Sharing and Programming Capability,” U.S. Provisional Application Ser. No. 61/453,748, filed Mar. 17, 2011, entitled “Smart Recipe File Format Standard,” and U.S. Provisional Application Ser. No. 61/453,759, filed Mar. 17, 2011, entitled, “Cooking Appliance with 1-way Voice Prompting.”

This application is also related to U.S. patent application Ser. No. ______ entitled “Methods and Systems for Appliance Community Service Management,” filed concurrently herewith under Attorney Docket No. 54151.154US2, and U.S. patent application Ser. No. ______ entitled “Methods and Systems For Coupon Service Applications,” filed concurrently herewith under Attorney Docket No. 54151.153US2.

All of the above-cited applications are incorporated herein by reference in their entirety.

### FIELD OF THE DISCLOSURE

The present disclosure generally relates to appliance connectivity and, more particularly, to methods and systems for device management with recipe sharing and programming capabilities.

### BACKGROUND

Technological advances have introduced a new level of connectivity to our society, allowing users to monitor and direct many aspects of their lives remotely. Household devices are typically stand-alone devices, and they are usually not connected to a broader network which may include other appliances and devices. Providing wireless management, sharing and programming capabilities allow users to communicate remotely with their devices, and thus exploit their devices more effectively and efficiently.

### SUMMARY

The following is generally directed to systems and methods for managing appliances on a network. By way of illustrative example, the systems and methods function to provide to a household appliance data containing food preparation instructions whereupon the device may instruct the user and/or automatically assist the user in preparing food in accordance with such instructions. To this end, the appliance may function to issue voice prompts to the user, provide video instructions, or the like. In addition, the system and method allows for the retrieval of recipes considering items within the household of the user, for example as manually provided to the system by the user and/or as automatically sensed by appliances in the household (such as by reading barcodes, taking images, and the like). Recipes created by users may be uploaded to the system and a standardized recipe file format is provided to allow for ease in disseminating such recipes. Recipes may also be uploaded to the system for the purpose of having ingredients ordered from a retailer for pick up and/or for delivery (for example those ingredients that may not be presently within the household).

While the foregoing generally describes various features of the systems and methods to be described hereinafter, a better understanding of the objects, advantages, features, properties and relationships of the systems and methods will be obtained from the following detailed description and accompanying drawings which set forth illustrative embodiments which are indicative of the various ways in which the principles of the invention may be employed.

### BRIEF DESCRIPTION OF THE DRAWINGS

For use in better understanding the subject system and method reference may be had to the following drawings in which:

FIG. 1 illustrates, in block diagram form, components of an example computer network environment suitable for implementing the example household device management system;

FIG. 2 is a system diagram of an example device management system;

FIGS. 3-6 are diagrams depicting a recipe management page flow usable in connection with the system of FIGS. 1 and 2;

FIGS. 7-10 are diagrams depicting a device management page flow usable in connection with the system of FIGS. 1 and 2; and

FIGS. 11A-11D depict example screenshots of a pages generated by the system of FIGS. 1 and 2 as presented on a mobile device.

### DETAILED DESCRIPTION

The following description of example systems and methods is not intended to limit the scope of the invention to the precise form or forms detailed herein. Instead, the following description is intended to be illustrative so that others may follow its teachings. Accordingly, and by way of example only, hereinafter is described systems and methods for providing device management with sharing and programming capabilities. In general, the disclosed examples allow for the management of a network enable appliance, for example, via use of monitoring techniques, information sharing techniques, and/or controlling techniques. In this manner, users may retrieve information, e.g., information related to recipes, and interact with their household devices under direction and/or remotely, e.g., to assist a user in preparation of any such recipes. Moreover, users may use information retrieved from their household devices in other applications, such as shopping, social networking, scheduling, food preparation, budget management, etc.

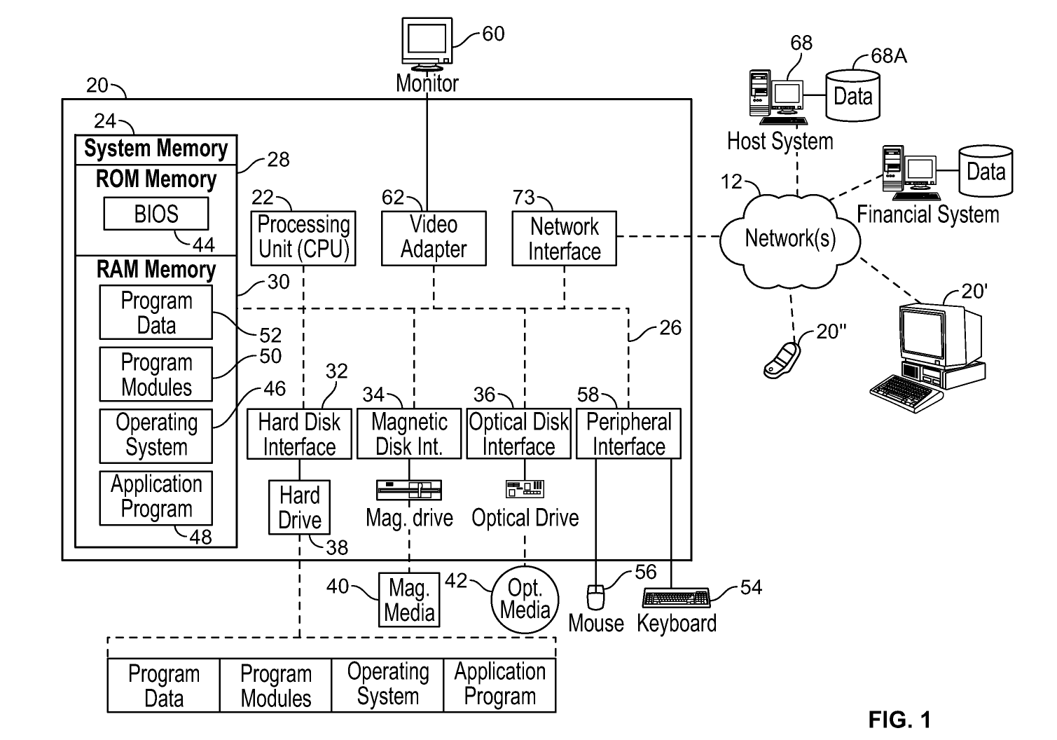

More particularly and with reference to the figures, the following discloses various systems and methods for providing, among other things, recipe management, recipe sharing, home automation (e.g., in connection with recipe preparation), voice prompting (e.g., to assist in recipe preparation), recipe viewing, recipe creating, and the like. To this end, FIG. 1 illustrates various processing devices 20 which may take the form of a mobile communication device 20″ such as a smart phone, a personal or laptop computer 20′, or even an appliance, such as a refrigerator, range, microwave oven, toaster over, and the like, without limitation. As shown in FIG. 1, such processing devices 20 will have access to executable instructions, for example as stored on a non-transitory computer readable media, which, when executed by a processing device, will function to provide a means for a customer, e.g., a user, consumer, etc., to interact with the device 20 and/or to access a host system server 68 for the purposes above described. Generally, the computer executable instructions reside in program modules which may include routines, programs, objects, components, data structures, etc. that perform particular tasks or implement particular abstract data types. Accordingly, those of ordinary skill in the art will appreciate that the processing devices 20, 20′, 20″ illustrated in FIG. 1 may be embodied in any device having the ability to execute instructions such as, by way of example, an appliance, a personal computer, mainframe computer, personal-digital assistant (“PDA”), cellular telephone, tablet, e-reader, or the like. Furthermore, while described and illustrated in the context of individual processing devices 20, 20′, 20″ those of ordinary skill in the art will also appreciate that the various tasks described hereinafter may be practiced in a distributed environment or a cloud computing environment having multiple processing devices/applications that are linked via a local and/or wide-area network whereby the executable instructions may be associated with and/or executed by one or more of multiple processing devices.

For performing the various tasks in accordance with the executable instructions, the example processing device 20 (which is intended to individually and collectively refer to any and all processing devices such as processing devices 20′ and 20″) includes a processing unit 22 and a system memory 24 which may be linked via a bus 26. Without limitation, the bus 26 may be a memory bus, a peripheral bus, and/or a local bus using any of a variety of bus architectures. As needed for any particular purpose, the system memory 24 may include read-only memory (ROM) 28 and/or random-access memory (RAM) 30. Additional memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated computer-readable media allow for the nonvolatile storage of computer-readable instructions, data structures, program modules and other data for the processing device 20. Those of ordinary skill in the art will further appreciate that other types of non-transitory computer-readable media that can store data and/or instructions may be used for this same purpose. Examples of such media devices include, but are not limited to, magnetic cassettes, flash memory cards, digital videodisks, Bernoulli cartridges, random-access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer-executable instructions comprising an operating system 46, one or more applications programs 48 (such as a Web browser, item/ingredient sensing/reporting application, recipe management application, voice prompting application, and the like), other program modules 50, and/or program data 52. Still further, computer-executable instructions may be downloaded to one or more of the computing devices as needed via a network connection.

To allow a user to enter commands and information into the processing device 20, input devices such as a keyboard 54 and/or a pointing device 56 are provided. While not illustrated, other input devices may include a microphone, a joystick, a game pad, a scanner, a camera, touchpad, touch screen, motion sensor, barcode reader (e.g., for reading barcode labels on grocery items) etc. These and other input devices would typically be connected to the processing unit 22 by means of an interface 58 which, in turn, would be coupled to the bus 26. Input devices may be connected to the processor 22 using interfaces such as, for example, a parallel port, game port, firewire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices not shown, such as, for example, speakers, cameras, printers, or another suitable device.

As noted, the processing device 20 may also utilize logical connections to one or more remote processing devices, such as the host system server 68 having associated data repository 68A. In this regard, while the host system server 68 has been illustrated in the exemplary form of a computer, it will be appreciated that the host system server 68 may, like processing device 20, be any type of device having processing capabilities. Again, it will be appreciated that the host system server 68 need not be implemented as a single device but may be implemented in a manner such that the tasks performed by the host system server 68 are distributed amongst a plurality of processing devices/databases located at different geographical locations and linked through a communication network. Additionally, the host system server 68 may have logical connections to other third party systems via a network 12, such as the Internet, LAN, MAN, WAN, cellular network, cloud network, enterprise network, virtual private network, wired and/or wireless network, or other suitable network, and via such connections, will be associated with data repositories that are associated with such other third party systems. Such third party systems may include, without limitation, systems of banking, credit, or other financial institutions, systems of third party providers of goods and/or services, systems of shipping/delivery companies, etc.

For performing tasks as needed, the host system server 68 may include many or all of the elements described above relative to the processing device 20. In addition, the host system server 68 would generally include executable instructions for, among other things, retrieving/creating recipes considering food items (e.g., possible recipe ingredients) in a user's household, retrieving/creating voice prompts, managing the sharing of recipes, rendering recipes into a standardized format, managing operations of appliances to be used during recipe preparation, and the like. Communications between the processing device 20 and the host system server 68 may be exchanged via a further processing device, such as a network router (not shown) that is responsible for network routing. Communications with the network router may be performed via a network interface component 73. Thus, within such a networked environment, e.g., the Internet, World Wide Web, LAN, cloud, or other like type of wired or wireless network, it will be appreciated that program modules depicted relative to the processing device 20, or portions thereof, may be stored in the non-transitory memory storage device(s) of the host system server 68.

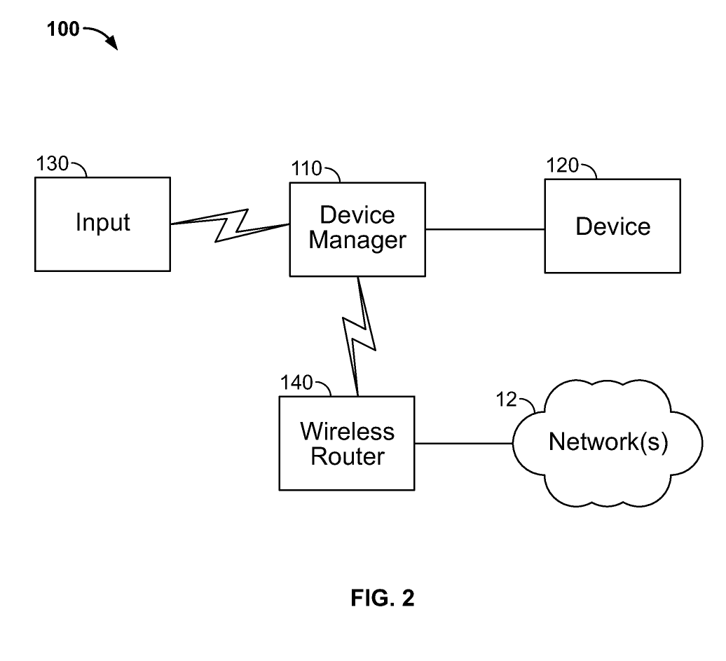

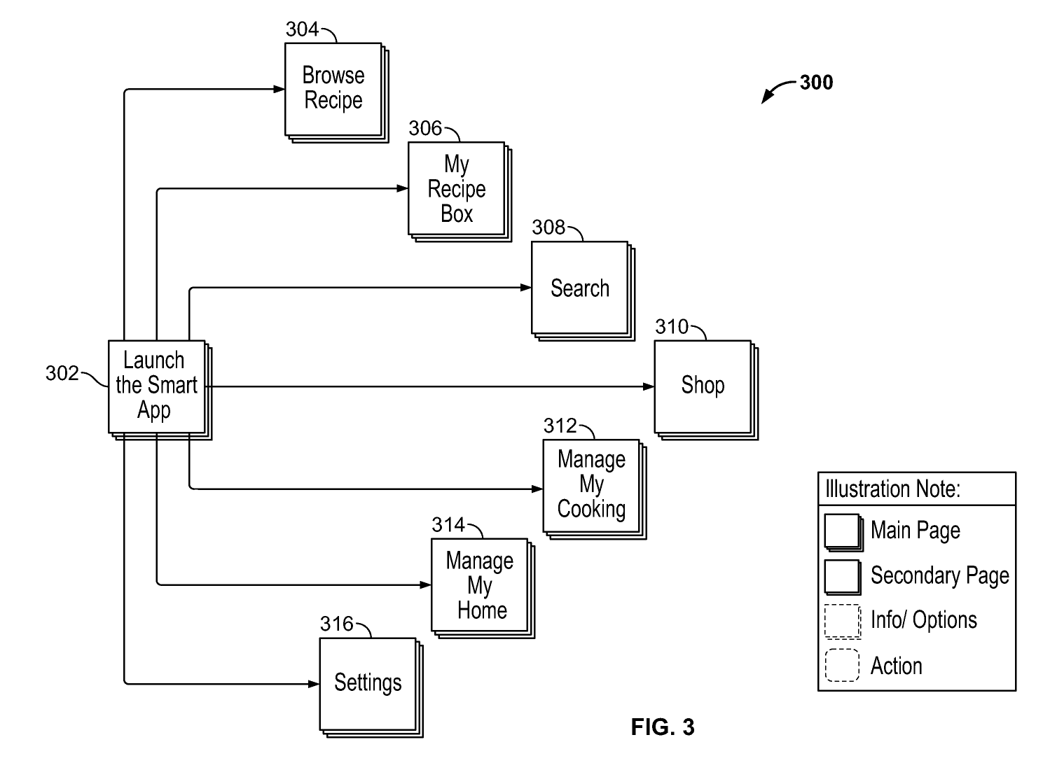

FIG. 2 illustrates an example device management system 100 arranged in accordance with one example of the present disclosure. In this example, the system 100 comprises a device manager 110 in communication with at least one device, such as a household device 120. The device manager 110 may be a computer program, mobile app, website, database, or the like. The device manager 110 may reside on, and provide required user interface elements as need for display, on an electronic device, such as, for example, a personal computer, a mobile device, a cellular phone, a personal digital assistant (PDA), a retail kiosk, and/or a physical medium using, such as, for example, the Internet, an internal network, or a social network.

The device 120 may be a household device such as a refrigerator and freezer unit, oven, microwave, pantry, slow cooker, bread machine, dishwasher, washing machine, dryer, tool chest, home entertainment system, television, coffee maker, etc. It will be understood that there are many other devices and/or appliances that may be used with the device manager 110 without departing from the spirit of the present disclosure. Furthermore, although the presently described embodiment comprises one device 120 in communication with device manager 110, it will be understood by one of ordinary skill in the art that a plurality of devices, such as the device 120 described in this embodiment, may be in communication with the device manager. In a preferred system, the device 120 (or additional devices within the system) are provided with sensors as needed for any particular application. By way of example only, the device 120 may have heat sensors (for monitoring cooking temperatures of an oven or stove top), a bar code reader (for sensing food items passed in front thereof), a camera (to allow for remote monitoring), and the like without limitation. The information gathered by such sensors or other input devices may be fed back to the system to, for example, facilitate the performance of a cooking task (such as to control appliance cooking temperatures), allow for remote monitoring/control of the appliance (such as via a mobile device app), etc.

The device manager 110 may be in communication with device 120 via Internet, LAN, MAN, WAN, cellular network, cloud network, enterprise network, virtual private network, wired and/or wireless network, Bluetooth, infrared, or other suitable network. In one embodiment of the invention, the device, such as a household device 120, may communicate information such as the status of the household device 120, the contents of the household device 120, the age of the household device 120, the condition of the household device's 120 contents, the condition of the household device's 120 component's, etc. to the device manager 110 via the network for processing in accordance with the functionality described herein.

For example, in one embodiment of the present disclosure, the household device 120 may be a refrigerator and freezer unit, and the household device 120 may communicate information such as the temperature of the refrigerator and freezer unit, food items contained in the refrigerator and freezer unit, the purchase date of the food items, the “best-by” date of the food items, the quantity of the food items, the purchase price of the food item, and/or any other relevant information.

In another embodiment of the present disclosure, the household device 120 may be an oven, and in that embodiment the household device 120 may communicate information such as the temperature of the oven, the oven time, etc. In another embodiment of the present disclosure, the household device 120 may be a dishwasher and in that embodiment the household device 120 may communicate the contents of the dishwasher, the status of the contents, the cycle that the dishwasher is in, etc.

In the embodiment shown in FIG. 2, the device manager 110 is in communication with a wireless router 140. The device manager 110 may transmit the information received from the device 120 to the wireless router 140 which in turn transmits the information to the host system server 68, or other suitable service, such as a cloud service through the network 12, including an Internet, cellular, wireless, wired, LAN, tethered, and/or any other suitable connection.

In the described embodiment the device manager 110 may also receive certain inputs 130 that the device manager 110 can use in coordination with the information received from the device 120. These inputs 120 may be, for example, images retrieved from a user's camera, information received from a UPC scanner, a user's location information (which may be utilized to automatically adjust recipes for altitude, etc.), desired (or a discerned preference) serving size information (which may be used to adjust the recipe accordingly) desired (or a discerned preference) preparation result (e.g., medium or well done which may be used to adjust temperature or time settings), text messages, emails, weather information, social updates, commands, etc.

As described above, via one or more input devices associated with the devices 120 (or otherwise provided in a household such as within a pantry, cabinet, etc.) the device manager 110 may compile an inventory list of the items—particularly food preparation items—that are located within a household. Among other things, the inventory list allows the user to remotely monitor items within the household. The inventory list may be a contemporaneous snapshot of the user's current household supply, and the device manager 110 may also monitor and save the user's inventory list history to determine and monitor the items that a user may need to replenish (e.g., to automatically order such items from a retailer for pickup and/or delivery). The device manager 110 may use the inventory list to suggests recipes that might be prepared using the current household inventory (or inventory that might be supplemented via a delivery and/or pick up from a retailer), to suggest items that could be purchased via a retail organization's catalog, to provide nutritional information, to retrieve item related information (including recipes) using information obtained from a user's social network, to analyze usage statistics, to develop a nutritional and/or diet plan, to sync information (e.g., replenishment information) with a user's calendar, share information on a social network, etc.

In another aspect of the present disclosure the device manager 110 may compile a list of a user's preferred items and organize the preferred items based on food group, seasonality, origin, brand, nutritional information, allergy information, etc. Such preferences may be explicitly provided to the system or may be discerned from historical usage. Such created preference listing may then be managed by the user, e.g., the user may add to or remove preferred items from the list compiled by the device manager 110 or otherwise organize the inventory list, for example, based on special dietary foods, holiday foods, nutritional information, seasonality, weight loss plan, family member preferences, etc. In this manner, when the system analyzes a user current household inventory, items within the preferred item list can be weighted when discerning recipes to suggest for a user considering the items within their household. For example, if the user shows a preference for peanut butter, the system may use the household inventory to suggest recipes in which peanut butter is a primary ingredient (provide peanut butter is or can be available for preparing such recipes). Similarly, items indicated as being preferred in keeping with a weight loss regimen (which items may be automatically selected for the user considering a specified weight loss regimen, e.g., the “South Beach Diet”) may be given preference when selecting recipes to suggest to the user. Recipes suggested based upon item preferences may be presented alone to the user or may be weighted by being presented at a top of candidate recipes considering the user's inventory.

In another aspect of the present disclosure the device manager 110 may use inputs 130 from a user's calendar. For example, the user's calendar may contain menu plans, social engagements, weight loss plans, nutritional information, etc. The device manager 110 may, for example, suggest purchases of certain items based on the ingredients needed for an upcoming menu plan, a visitor with certain dietary restrictions, and/or a user's weight loss and/or nutritional goals. The device manager 110 may also use a user's calendar in order to set up future social engagements, coordinate shared purchases, plan community events, coordinate shopping events, etc. The device manager may distribute invitations, and facilitate group chats, group voting, group messaging etc. By way of example the device manager 110 may extend a picnic invitation to a number of additional users and each additional user may respond with the items that they are bringing (or the system may suggest, based upon the inventory in each parties household, the items that each person should bring to provide a complete meal).

In another aspect of the present disclosure the device manager 110 may use the inventory list and/or a user's historical inventory list to set recurring orders for certain items. In another aspect of the present disclosure, the device manager 110 may sync with a tax preparation application in order to determine and track which items are tax deductible, e.g., when food items are being provided by an organization for charitable purposes.

In another aspect of the present disclosure the device manager 110 may use the inventory list to generate and suggest retail offers from a retail organization. Such suggestions may be communicated via an email, instant message, an app, voice message, pop up display, and the like. The device manager 110 may receive inputs 130 from a retail organization about retail offers that are currently available. The device manager 110 may then use the inputs 130 received from the retail organization in combination with the inventory list and/or a user's inventory list history to develop and/or suggest retail offers. For example, the device manager 110 may suggest a retail offer for items that a user is low on, an item that complements a user's current inventory list, an item on a user's preferred item list and/or an item from a user's shopping list. In another example, device manager 110 may suggest a retail offer from an alternative brand as compared to the brand that a user currently possesses, and/or a brand that is currently on a user's preferred item list.

In another aspect of the present disclosure, the device manager 110 may also redeem retail offers received from a retail organization. For example, the device manager 110 may operate on a cellular phone, tablet, computer, laptop, PDA etc. and a user may use the device manager 110 to redeem retail offers when online shopping, and/or during in-store purchases.

In another aspect of the present disclosure the device manager 110 may monitor the prices of certain items using information received from one or more retail organizations. The device manager 110 may monitor the sales prices of items such as a user's preferred item and/or items on a user's shopping list, and alert the user when the item reaches a certain sales price. The device manager 110 may also track historical price information for certain items, such as the average local price, the price trend, the seasonal average price, the current price as compared to the average price, etc. Such pricing information may also be utilized to suggest recipes to a user, e.g., to suggest a low cost meal for preparation.

In another aspect of the present disclosure the device manager 110 may allow a user to browse through coupons using motion activation, voice command, hand gestures etc. In another aspect of the present disclosure the device manager 110 allows a user to share coupons through email, social networks, wireless networks, Bluetooth, LAN etc.

In another aspect of the present disclosure, the device manager 110 may develop and suggest instructions sets. For example, if the device 120 is an oven, the instruction set may be instructions for operating the stove-top burners, e.g., in accordance with a recipe. As noted above, these instructions can be in form of voice prompts, e.g., set burner at 2 to simmer.

As noted above, the device manager 110 may suggest recipes based on, for example, the items currently on a user's inventory list, a user's personal preferences, a user's stated preferences, and categories such as cuisine type, seasonality, occasion, ratings, popularity, nutritional information, allergy information, etc. The device manager 110 may also allow users to input recipes, for example by selecting existing recipes from online databases, manually inputting recipes, inputting recipes using a digital scanner, capturing a recipe using a camera, etc.

In another aspect of the present disclosure, the device manager 110 may use a recipe to automatically add and/or suggest items for a user's shopping list. The device manager 110 may also suggest side dishes, desserts, beverage accompaniments, etc. based on a user's selected recipes, inventory list, shopping list, available retail offers, calendar, social network updates, etc. In another aspect of the present disclosure, the device manager 110 may use inputs 130 such as information received from a UPC scanner, and/or a camera identifying an item(s) at a retail location. The device manager 110 may use the item(s) identified while in a retail establishment to suggest recipes further considering the household inventory list.

In another aspect of the present disclosure, the device manager 110 may receive recipes from a recipe database, a recipe subscription service, recipes published in magazines and/or periodicals, recipes from selected cookbooks, recipes etc. In another aspect of the present disclosure, a user may purchase recipes to send to the device manager 110 from an online store. For example, the user may select a recipe from a recipe database, the user may sync the device manager 110 with an existing account containing a plurality of recipes, the user may “drag and drop” recipes using a user interface, etc. In another aspect of the present disclosure, a user may scan recipes written in materials such as a book, magazine, newspaper, etc.

In another aspect of the present disclosure, the device manager 110 may allow users to organize recipes on the device manager 110. For example, a user may sort recipes based on categories such as keywords, food group, ratings, nutritional information, seasonality, source, diet, etc. The user may also delete and remove recipes that the device manager 110 has received. In another aspect of the present disclosure, a user may create a recipe using the device manager 110, for example, adding items from an inventory list, adding items from a shopping list, etc.

In another aspect of the present invention, the device manager 110 may use a recipe to send commands to automatically control operations of a device, such as, temperature settings, cook time, sequence of temperature settings, reminders, etc. Appliance operating instructions (as well as other recipe steps) can be verbalized to the user via a speaker or the like. In another aspect of the present disclosure, the device manager 110 may use a recipe to search for ingredients from an inventory list of a device 120. For example, the device manager 110 may search for ingredients required and/or suggested in a recipe. In another aspect of the present disclosure, the device manager 110 may display tutorials, videos, illustrations, demonstrations etc.

In another embodiment of the present disclosure, the device manager 110 may receive information and commands from multiple users. For example, the device manager 110 may access calendars for multiple users for the purposes of meal planning, holiday planning, birthday planning, schedule coordination, and other multi-user events. The device manager 110 may allow users to select recipes, shopping list items, inventory list items, wish list items, etc. for certain calendar events. In addition, the users may use the device manager 110 to schedule social activities at public venues, such as restaurants, theme parks, movie theatres, entertainment centers, shopping malls, etc. and the device manager 110 will automatically search for coupons for those venues. In another aspect of the present disclosure, the users may ask the device manager 110 for suggestions for social activities and/or public venues by inputting information such as user preferences, retail offers, locational data, etc.

In another aspect of the present disclosure the device manager 110 may make an inventory list of items based on their location, for example, kitchen, living room, dining room, laundry room, bed room, garage, workshop, home office, etc. In another aspect of the present disclosure the device manager 110 may allow users to organize items in an inventory list based on where they are purchased.

In another aspect of the present disclosure the device manager 110 may be used for budgeting purposes. For example, the device manager 110 may receive inputs 130 from the user such as weekly, daily, monthly, or yearly budgeting goals. The budgeting goals may be further divided based on category of spending, calendar events, type of items purchased etc. The device manager 110 may track spending based on items on a device's inventory list, and/or items on a user's shopping list. The device manager 110 may also provide budgeting information based on information retrieved from retailers, such as price information and retail offers. Additionally, the device manager 110 may track a user's savings based on his or her purchase history, inventory list, shopping list and/or information about retail offers. The device manager 110 may also track historical budgeting, expenditure, and savings information. The device manager 110 may also use locational data to identify item prices at retail locations both in-store and online.

In another aspect of the present disclosure, the device manager 110 may allow a user to communicate and connect with additional users. For example, the device manager 110 may allow a plurality of users to participate in group buying for volume discounts. In another aspect of the present disclosure, the device manager 110 may allow users to send alerts, messages, reminders, etc. to users regarding items on their inventory list, items on their shopping list, retail offers, device status, recipes etc. The device manager 110 may also allow users to post information and/or updates on social networking sites regarding items on their inventory list, items on their shopping list, retail offers, device status, recipes, etc. The device manager 110 may also be used for gaming purposes, for example, allowing users to participate in a game tracking their purchases, recipe usage, etc. (e.g., by earning badges for trying recipes of a given genre or using give ingredients).

In another aspect of the present disclosure, the device manager 110 allows users to customize their privacy settings to determine the amount and nature of information to share with the device manager, other users, social networks, retail organizations, etc.

In another aspect of the present disclosure, the device manager 110 may be used to control settings on the device 120. For example, if the device 120 is a refrigerator and freezer unit, the device manager 110 may receive information from an app running on a remote device, such as a smart phone, to allow a user to remotely control the temperature of the device. In another example, if the device 120 is an oven, the device manager 110 may be used to remotely turn the oven on for pre-heating purpose, and/or remotely turn the oven off. If the device 120 is a dishwasher, the device manager 110 may be used to remotely turn the dishwasher on, or change the dishwasher's settings at the user's command.

The device management system 100 of the present disclosure may give and respond to voice commands. For example, the inputs 130 may be in the form of vocal commands from a user, e.g., to set the device to a particular temperature or setting. In another aspect of the present disclosure, the device manager 110 may communicate reminders, alerts, and instructions via audible commands. For example, the device manager 110 may read a selected recipe, notify users of the inventory list, notify users of items on a shopping list, notify users of retail offers, notify users of a device's status, instruct the user of the preparation steps, etc. The device manager 110 may allow users to turn the voice function on and off. The device manager 110 may also allow users to select the language for the voice function.

The device manager 110 of the present disclosure may be displayed and/or formatted in HTML, JSON, XML and/or any other appropriate format. In another aspect of the present disclosure the device manager 110 may present recipe data in a standardized format. For example, the standardized recipe format may comprise programming instructions for a cooking appliance (e.g., pre-programmed mode settings, temperature settings, timer settings, etc.); labels and sorting criteria; keyword search tags; caloric information; recipe ingredients and instructions; ingredient substitutions and possible modifications; coding for different output modes. Further, the standardized recipe format may include embedded data as needed.

The device manager 110 may also have a retail application. For example, a user may place an order for the purchase of items through a touch screen, using audio input, using, and/or by scanning an item. For example, the device 120 may comprise a scanner that allows a user to scan an item that the user wishes to purchase. Then, the device manager 110 may communicate with a retailer to purchase that item. In one illustrative example, the device 120 may be a refrigerator, comprising a UPC scanner. When a user scans a food item, the device manager 110 may communicate an order to a retailer and place an order for that item.

In another aspect of the disclosure, the user may select the retailer to purchase the item from, before the device manager 110 sends the order. In another aspect of the disclosure, the user may set preferred retailers that the device manager 110 purchases from. In another aspect of the present disclosure, the device manager 110 may present the user with competing prices for a selected item.

By way of further example, FIG. 3 depicts a page flow 300 that can be used to present information and/or control options to an end user. In the illustrative example, from a home page 302 (e.g., presented on a display of an appliance, a smart phone, etc.) a user can navigate to recipe browse page(s) 304 (e.g., a page to browse posted recipes, suggested recipes, and the like), my recipe page(s) 306 (e.g., a page to browse tagged or otherwise stored recipes), search page(s) 308 (e.g., a page that presents drill down or keyword searching for recipes locally stored or remotely accessible), shop page(s) 310 (e.g., a page for ordering items from a retailer, for reviewing items suggested by the system for ordering, for managing recurring orders that may have been created, for accessing pricing, coupons, etc., for creating recurring orders, and the like), manage my cooking page(s) 312 (e.g., for indicating recipe preferences, item preferences, and the like), manage my home page(s) 314 (e.g., for controlling the appliance directly and/or for controlling other appliances remotely), and settings page(s) 316 (e.g., for managing the settings of the app providing the functionality—such as polling frequency, social network linking, turn on/off voice prompts, and the like). As will be understood, additional pages for use in accessing, uploading, downloading information and/or for providing controls associated with appliance operations may be included as needed for any particular purpose.

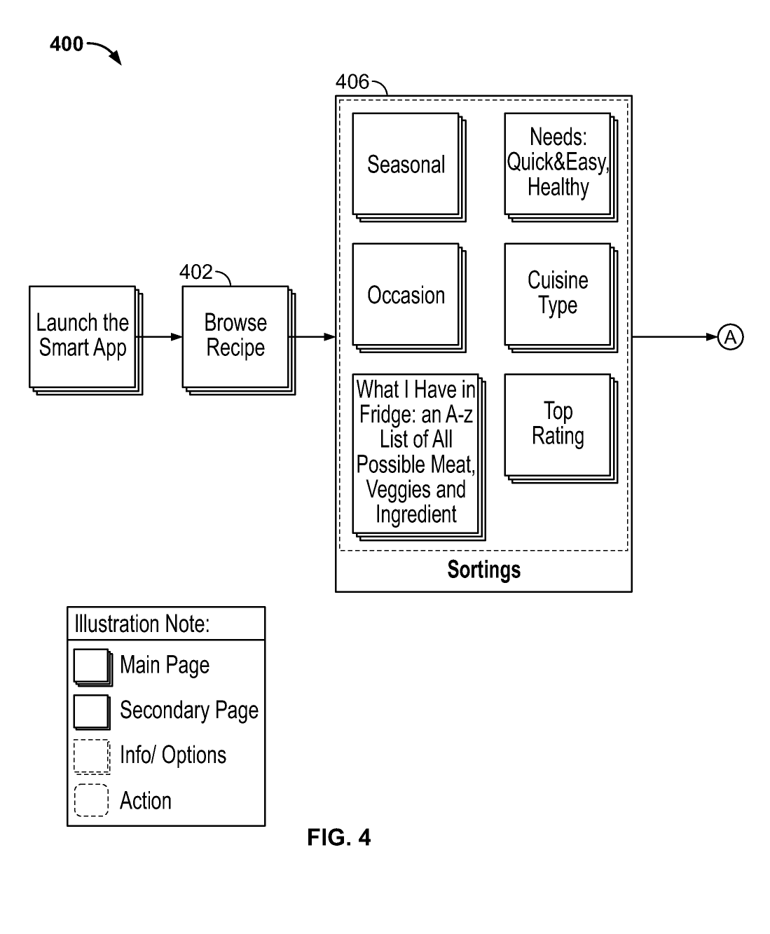

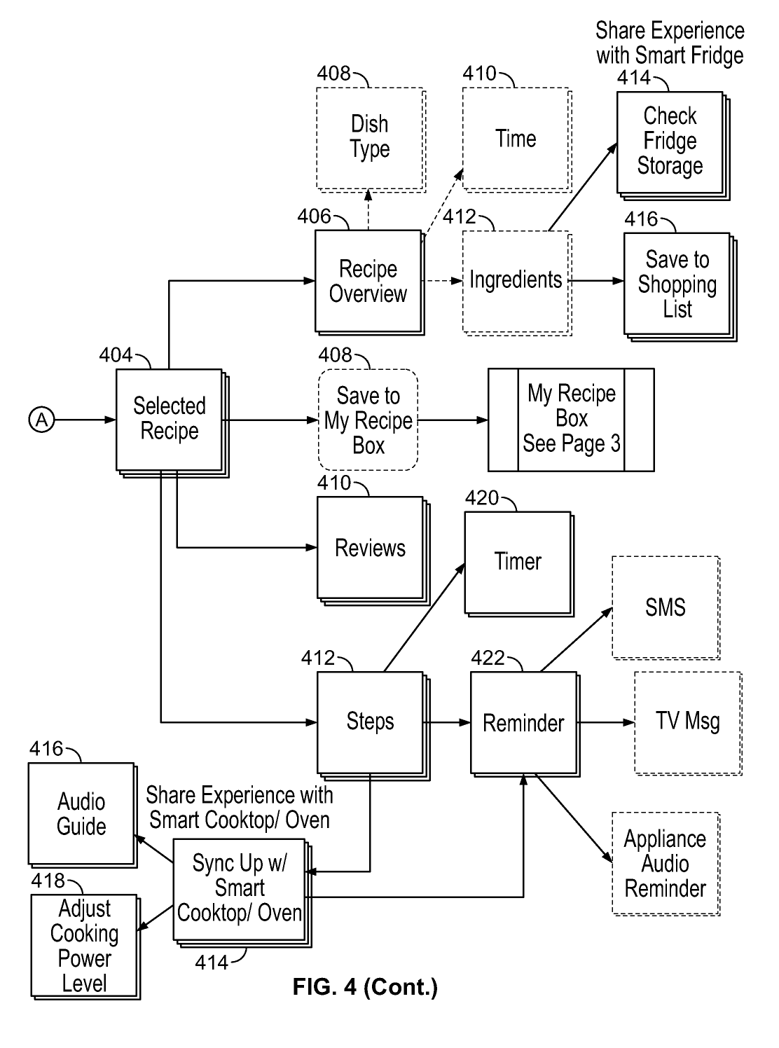

By way of more particular example, FIG. 4 depicts a page flow 400 for browsing recipes in accordance with the above. For example, from a browse recipe home page 402, a user can sort 406 recipes (whether locally stored or remotely accessible) based on season, occasion, what is currently in the house (which may be manually entered, discerned from prior usage, discerned from shopping recaps, discerned from sensor, etc.), cuisine type, ratings (e.g., as provided by the user, associates within a social network of the user, or more generally), and needs (e.g., dietary). The user may then select a recipe 404 for viewing 406, saving 408, reviewing 410 (which review can be shared with the social network of the user or more generally posted), and/or for retrieving the steps for use in preparing the recipe 412. When a user indicates that an overview 406 of a recipe is to be viewed, the system may then present to the user information concerning one or more categories for the recipe 408 (e.g., dish type), estimated time needed for preparation 410, ingredients required 412, and/or overall difficulty rating. In addition, the system may check the household inventory list to determine 414 if the ingredients (or utensils required) are present in the household and, if necessary, may automatically add 416 any missing ingredients (or utensils required) to a shopping list accessible by the shopping page(s) above noted.

In the event a user indicates a desire to execute the recipe 412, the system may communicate 414 required appliance setting to the appliance(s) that will need to be used during the preparation process. The appliance may also be controlled to provide audio, preparation instructions 416 to the user throughout the preparation process while controlling the appliance 418 and/or timer 420 as required. Reminders for instruction steps (e.g., check oven) may be issued 422 to the user throughout the cooking process, for example via SMS messages, TV overlays, from the appliance itself, etc. As will be understood, any instructions for the appliance(s) can be included as part of the metadata that is included with the above-described uniform recipe.

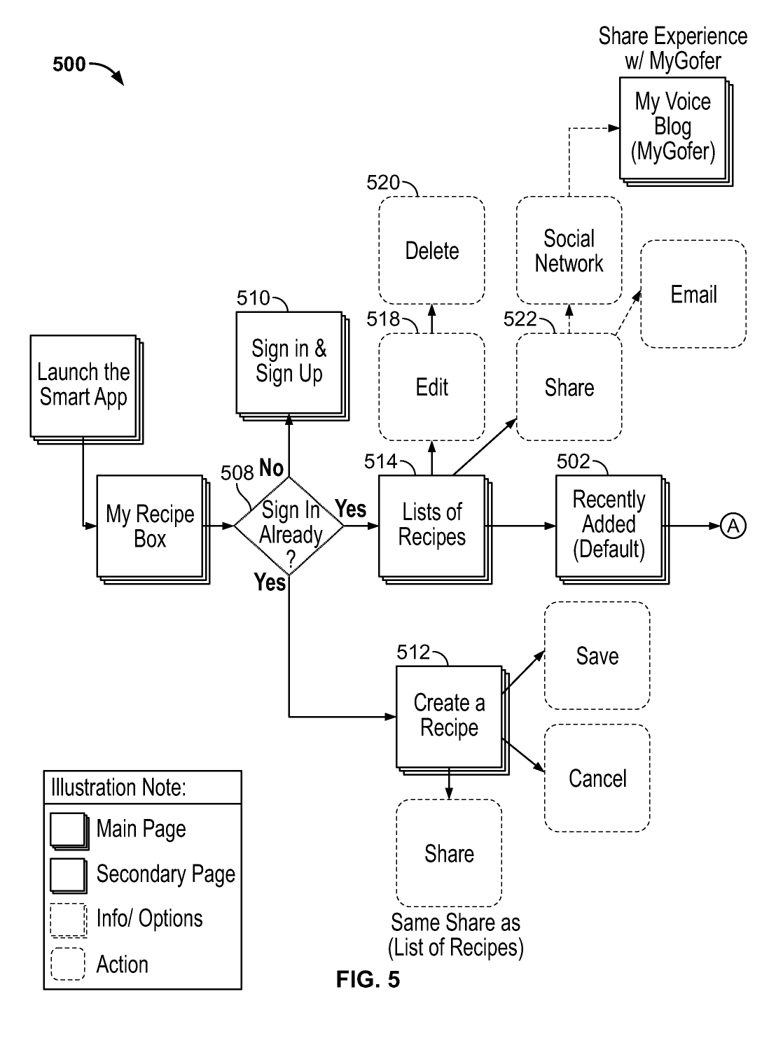

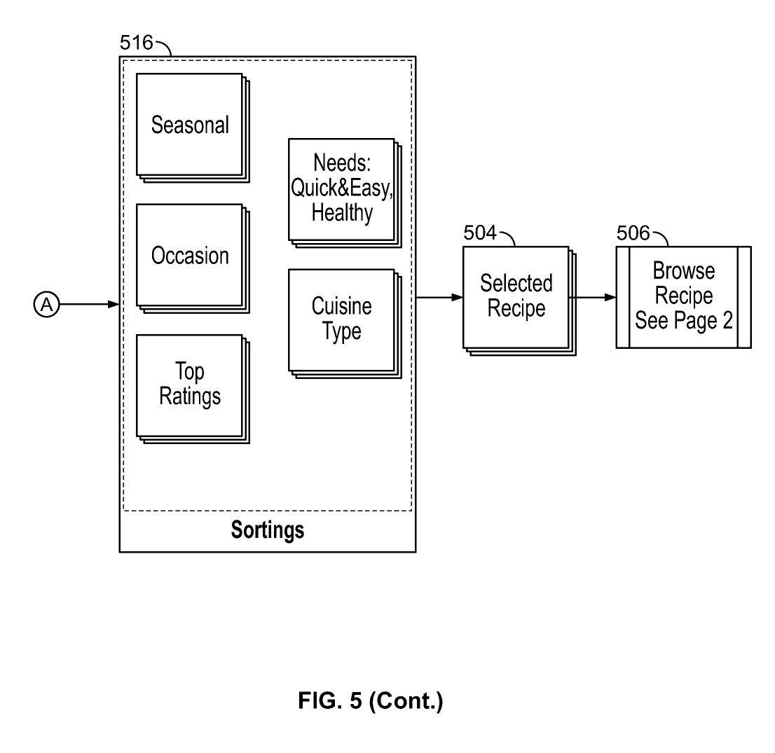

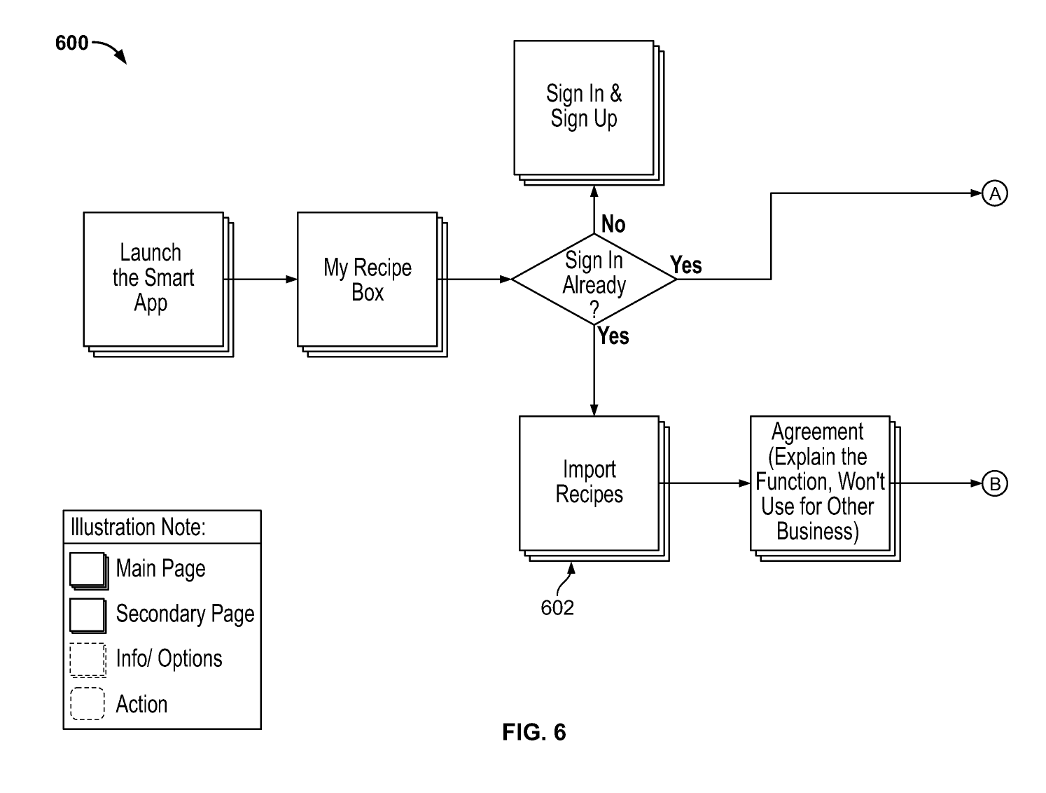

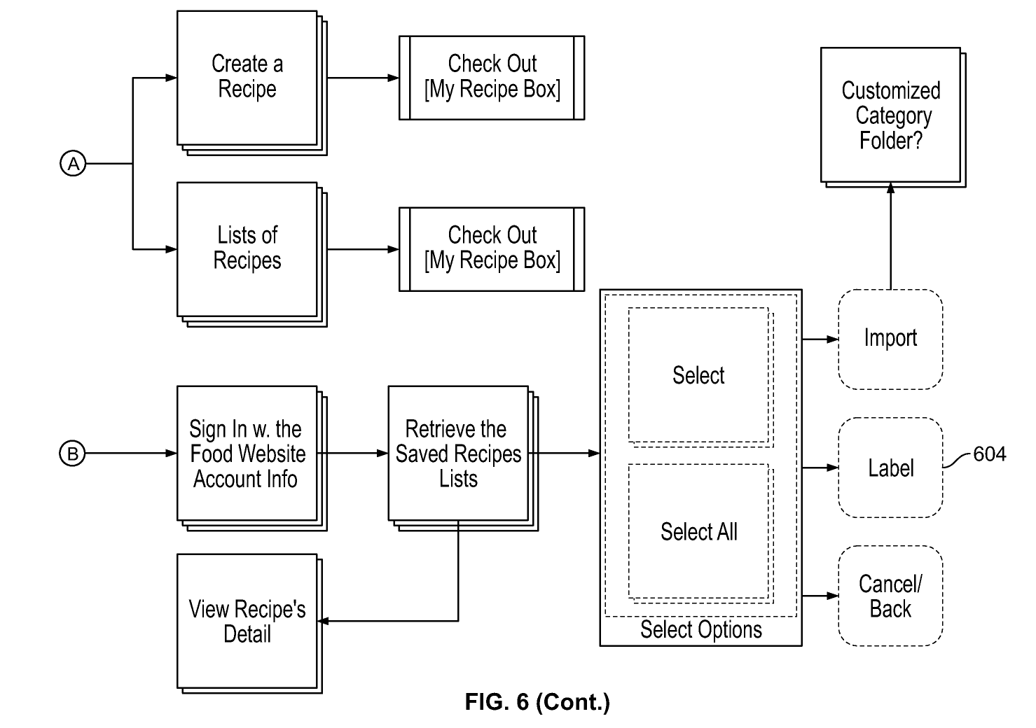

In the event that the user navigates to the my recipe box page(s), the system follow a flow 500 wherein the system may first determine 508 if the user is recognized by the system, e.g., is logged in, as shown in FIG. 5. The user may be asked to sign-in or otherwise register with the system 510 if they are unrecognized. If recognized, the user may interact with the my recipe box page(s) to create a recipe 512 (which can then be shared, saved, or deleted) or access a list of already created recipes 514. The list of already created recipes can be search and/or sorted 516, selected 504, browsed 506, edited 518, deleted 520, and/or shared 522 without limitation. As additionally illustrated, sharing can be accomplished through use of social networking tools, by email, and the like. As further illustrated in FIG. 6, via use of the my recipe page(s) flow 600, the user can additionally import recipes 602 from other sources, e.g., from a food website which may or may not require the paying of a fee and/or compliance with a third-party access agreement. Imported recipes can be tagged/labeled 604 for access as described above in connection with FIG. 5, placed into a folder, etc.

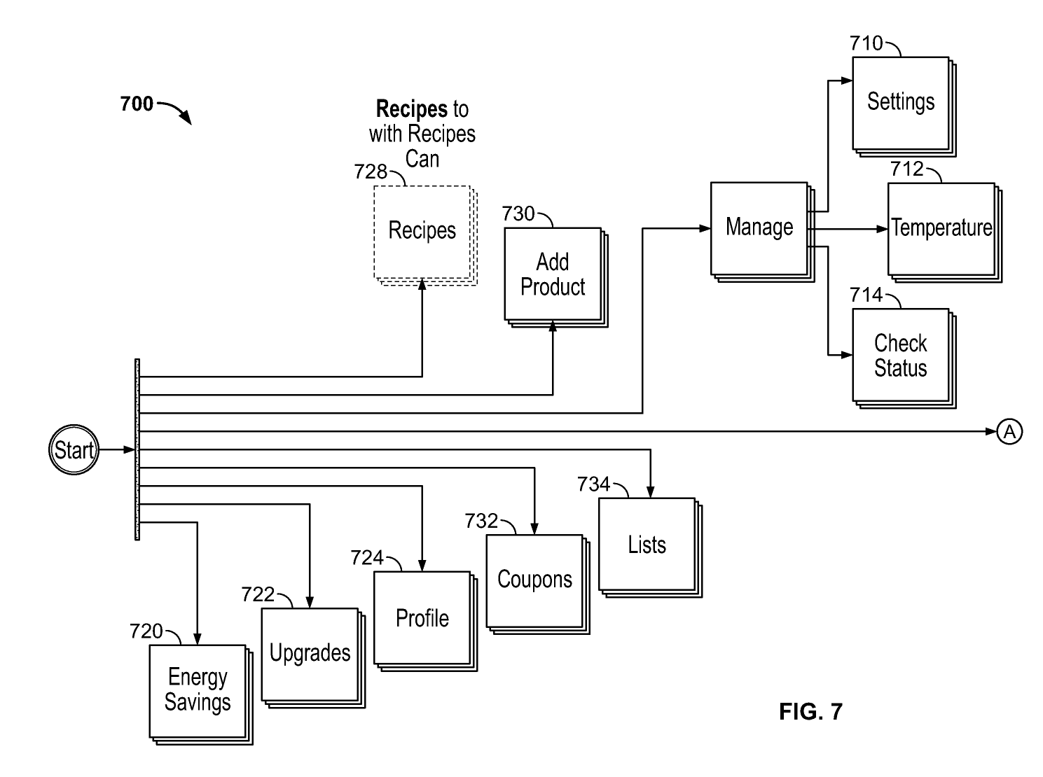

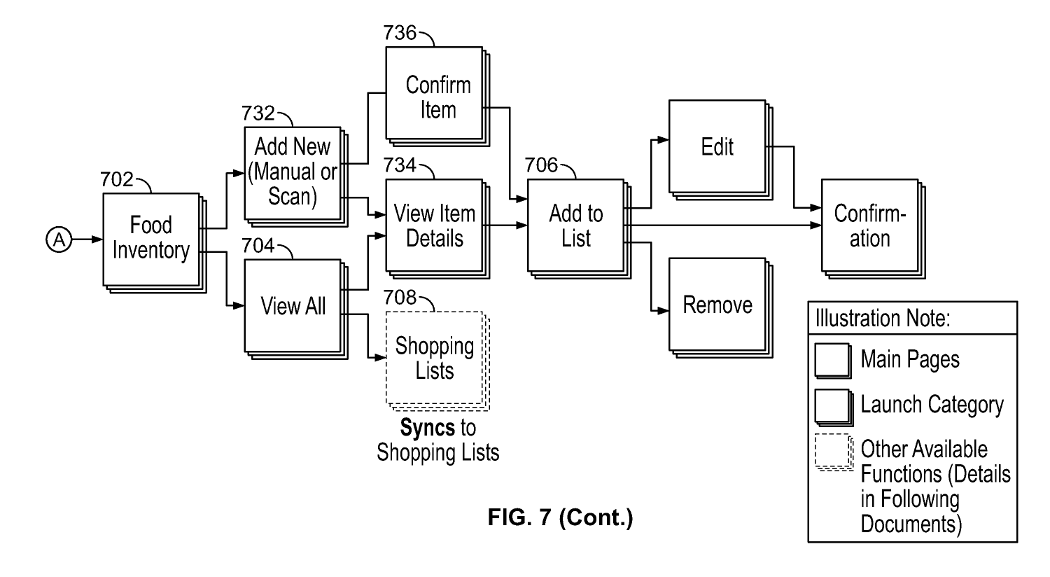

Considering now FIG. 7, a page flow 700 for accessing information and/or controls as provided by the device manager is illustrated. By way of example, the device manager may make available page(s) for establishing (or for retrieving for automatic use) appliance energy settings 720, for determining if firmware/software upgrades are available and/or for downloading the same to the appliance 722, for establishing a user profile (or appliance profile as needed) 724, for accessing recipes 728 (as described above), for adding product to a shopping cart or another list 730, for viewing, accessing, and/or retrieving coupons 732, for accessing, editing, deleting or otherwise managing lists 734, for managing the operation of the appliance (e.g., to establish appliance settings 710, temperatures 712, to check operations status 714, etc.), and/or to manage the food inventory 702. For managing food inventory, the device manager may provide additional page(s) for allowing a user to view 704 the current household inventory (and to shop 708 thereafter as needed) or to search 732 the current household inventory. The user may then obtain more details 734 with respect to an inventory item, e.g., cost, ingredients, nutritional information, etc., confirm 736 that the item is, in fact, in inventory, add an inventory item to a list 706 (and/or to edit lists, delete lists, etc.).

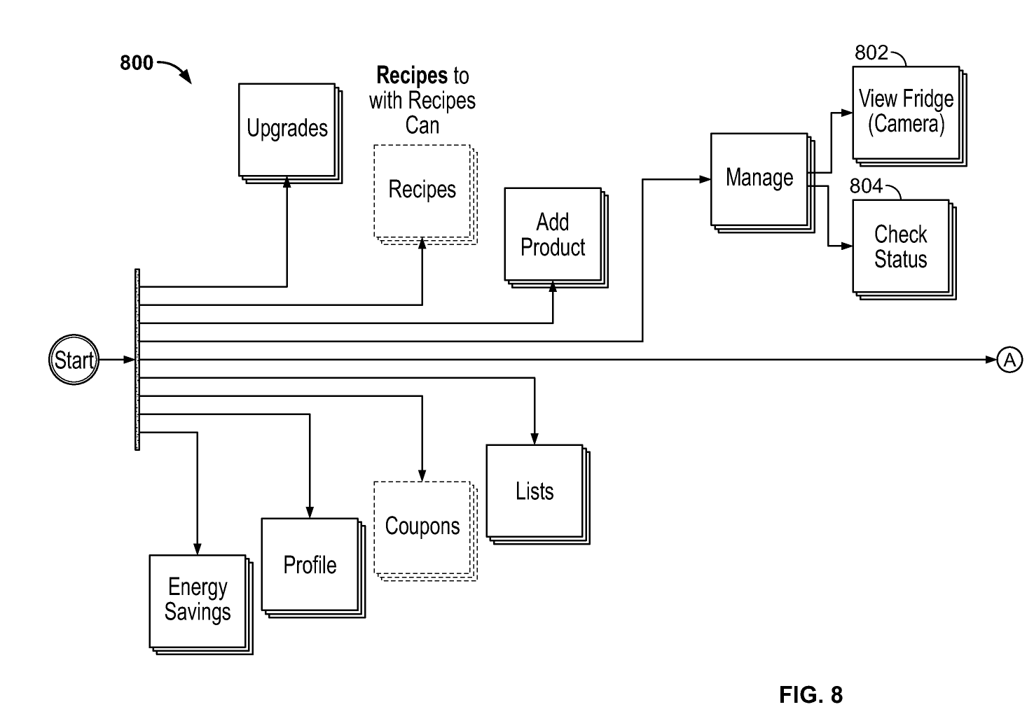

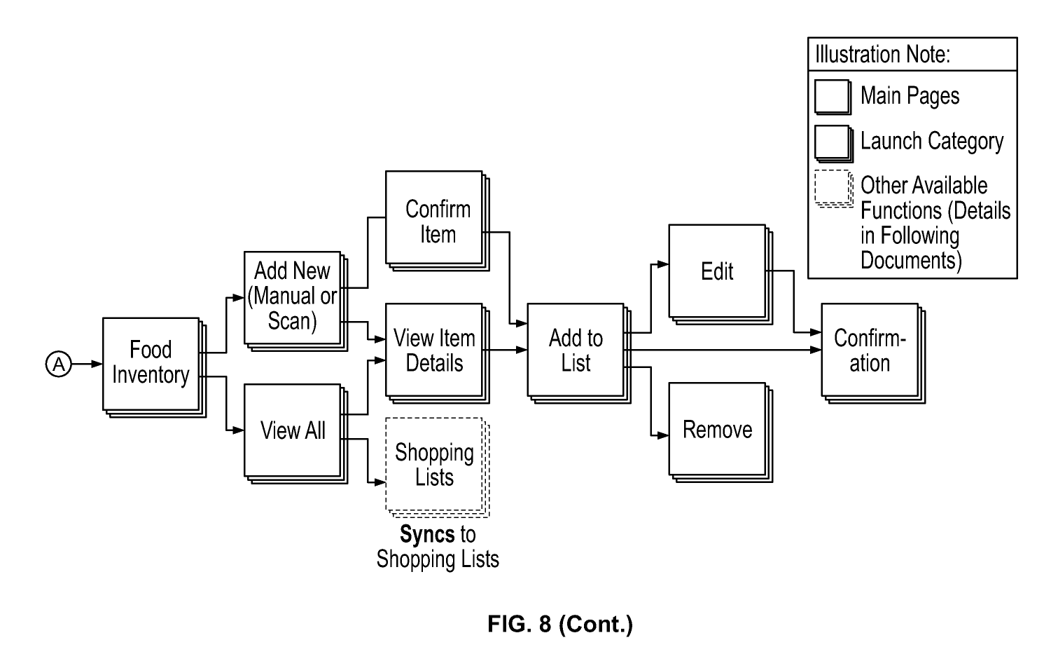

In a similar manner, FIG. 8 depicts a page flow 800 that also provides for a user to remotely monitor an appliance, e.g., view a camera 802 associated with the appliance and/or to check other operations statuses of the appliance 804 as reported to the device manager by the appliance.

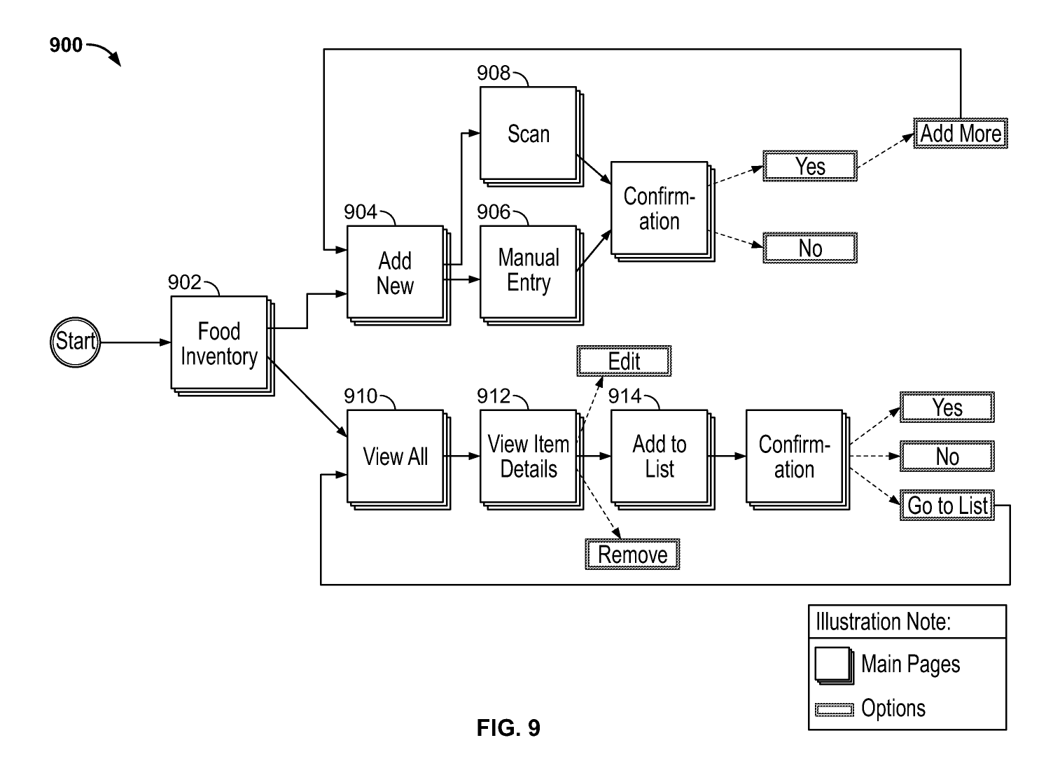

In FIG. 9 a page flow 900 for use in connection with managing food inventory is illustrated. To this end, the device manager 110 may present page(s) for allowing a user to view inventory information 910 as well as to add items to the inventory 904. As described above, adding items to the inventory can involve manual entry of item information 906 (which may assisted by the use of drill down menus or the like) or semi-automated entry of item information 908 (e.g., by a user passing an item in front a barcode scanner). As also described above, this process need not be specifically invoked but can be constantly on, e.g., items can be continually scanned as they are placed into and removed from a refrigerator, pantry, or the like. As still further described above, from the listing of inventory a use can indicate a desire to view more detailed information with respect to one or more items in inventory 912 or cause one or more items to be placed into a list 914, such as a shopping or wish list.

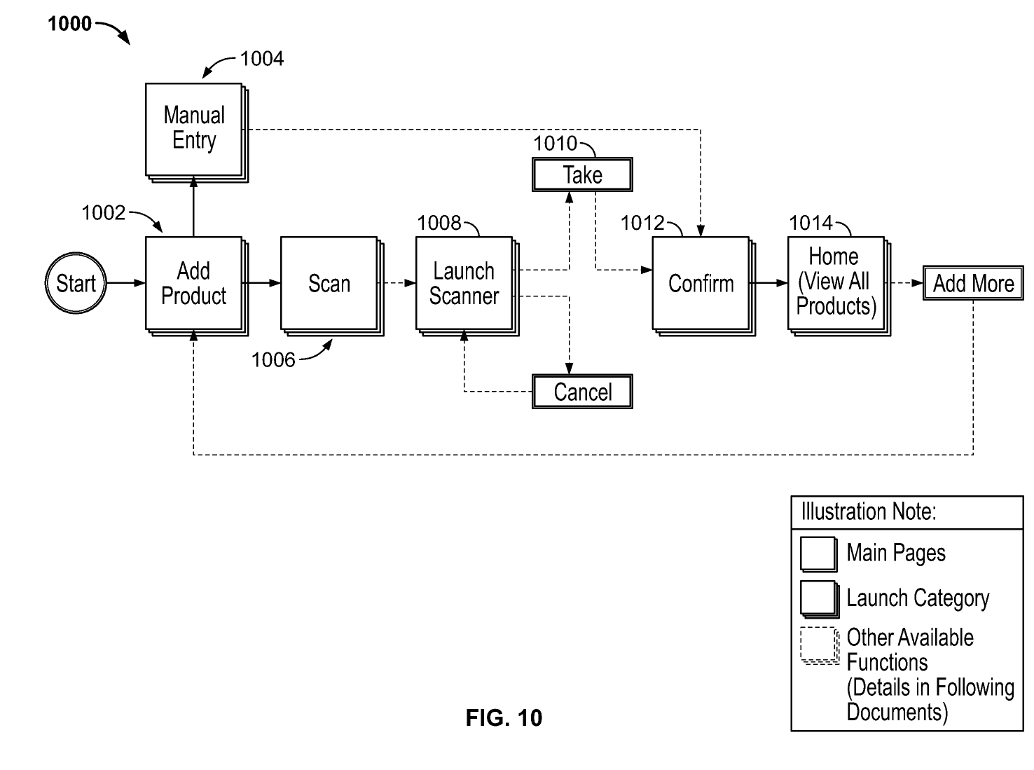

In FIG. 10 a page flow 1000 for adding product to inventory is illustrated in additional detail. In the exemplary page flow, when a user indicates a desire to add a product 1002, the user may be presented with the option to manually enter product information 1004 or semi-manually product information 1006 as noted above. When the product information is to be semi-manually entered, the system may cause a scanner to become operational 1008 with the user being instructed to pass a product in front of the scanner. In the event that the product is determined to have been scanner 1010, information for the product is retrieved and displayed to the user for confirmation that the information corresponds to the product 1012. Once entered in this manner, the user can again access the inventory listing 1014 for the purposes above-noted.

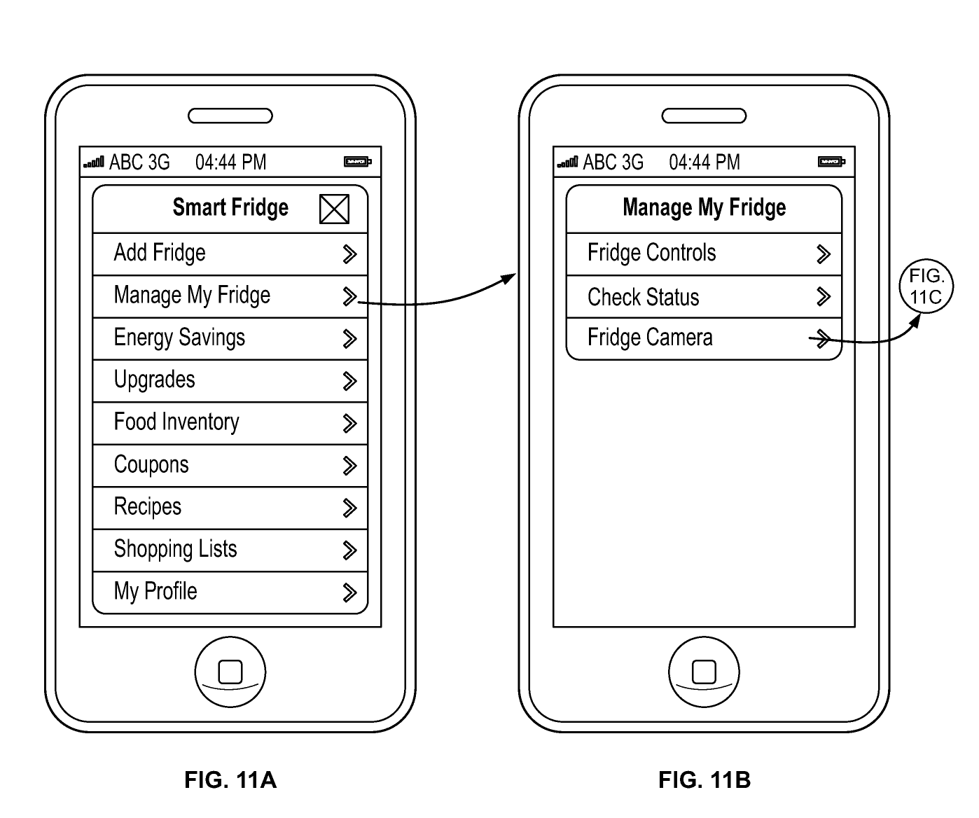

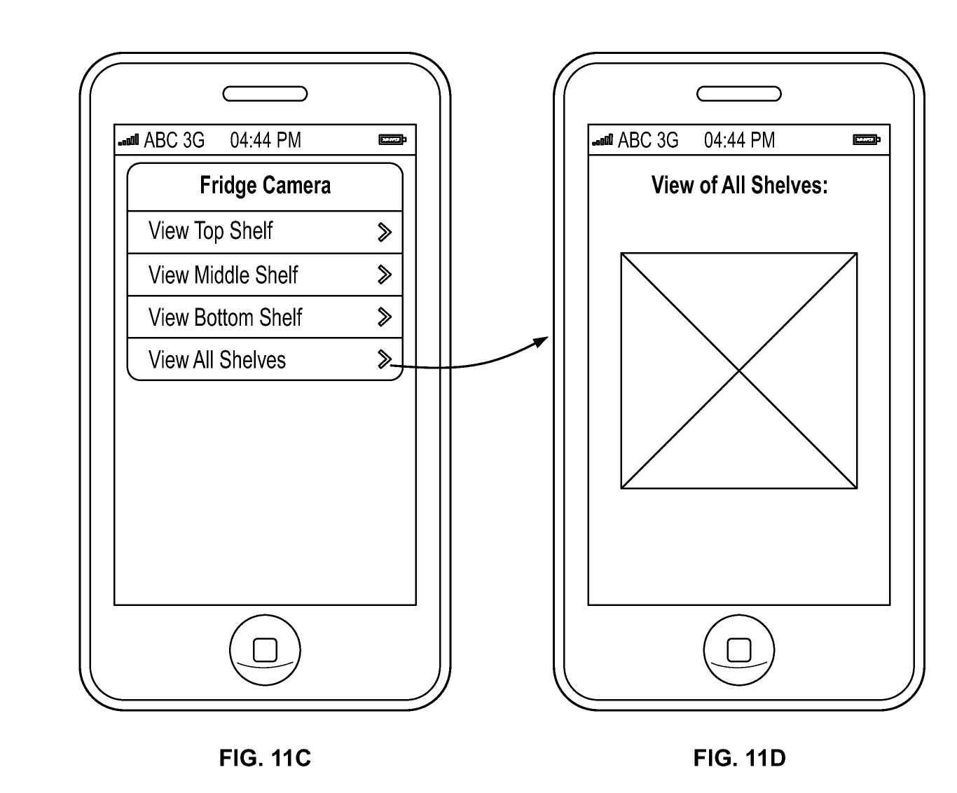

Considering now FIG. 11A, illustrated is a screenshot of an example embodiment of a device management page as presented on a smart phone via use of a smart phone app in communication with the system. From this page a user can access the further page(s) as noted above to perform the various described functions associated therewith, e.g., to manage the device, to upgrade the device, to access coupons, to access recipes, etc. By way of further example, FIG. 11B illustrates a smart phone displaying a navigated to manage my fridge page by which a user can access further page(s) that provide functionality associated with this selected option, such as remotely viewing/controlling a camera installed in the fridge to thereby remotely view one or more shelves in the fridge as shown in FIGS. 11C and 11D.

While specific embodiments of the invention and examples of its use have been described in detail, it will be appreciated by those skilled in the art that various modifications and alternatives to those details could be developed in light of the overall teachings of the disclosure. For example, voice prompts can be provided in a selected language, may be used to provide use and care information, provide general salutations upon sensing an individual entering or leaving a location, etc. Accordingly, the particular arrangements disclosed and examples provided are meant to be illustrative only and not limiting as to the scope of the invention which is to be given the full breadth of the appended claims and any equivalents thereof.

What is claimed is:

1. A non-transitory, computer-readable media having stored thereon computer executable instructions which, when executed by a processing device, perform steps for device management, comprising:
retrieving at least one data set containing food preparation instructions; and
using the retrieved at least one data set to control one or more operations of at least one food preparation device.

2. The computer-readable media as recited in claim 1, comprising using the retrieved at least one data set to provide audible instructions in accordance with the food preparation instructions.

3. The computer-readable media as recited in claim 1, wherein the instructions use an inventory of product within a household to retrieve the at least one data set containing food preparations instructions.

4. The computer-readable media as recited in claim 3, wherein the instructions create the inventory of product via use of one or more sensors associated with one or more food repositories within the household.

5. The computer-readable media as recited in claim 4, wherein the one or more food repositories comprise one or more of a refrigerator, a freezer, a pantry, and a cabinet.

6. The computer-readable media as recited in claim 4, wherein the one or more sensors comprises a barcode scanner.

7. The computer-readable media as recited in claim 4, wherein the one or more sensors comprises an image capturing device.

8. The computer-readable media as recited in claim 4, wherein the instructions provide remote access to the information generated by the one or more sensors for use in remote appliance monitoring.

9. The computer-readable media as recited in claim 4, wherein the instructions use the inventory of product to automatically populate a shopping cart of an ecommerce vendor.

10. The computer-readable media as recited in claim 1, wherein the data set comprising food preparation instructions comprises a recipe having appliance control metadata associated therewith.

11. The computer-readable media as recited in claim 1, wherein the instructions use a preferred ingredient to retrieve the at least one data set containing food preparations instructions.

12. The computer-readable media as recited in claim 1, wherein the instructions use a menu created amongst a plurality of linked users in a social network to retrieve the at least one data set containing food preparation instructions.

13. The computer-readable media as recited in claim 12, wherein the menu is created based upon an inventory of product in a household associated with each of the linked users in the social network.

14. The computer-readable media as recited in claim 1, wherein the instructions facilitate access to instructional videos associated with the food preparation instructions.

15. The computer-readable media as recited in claim 1, wherein the instructions use the at least one data set containing food preparation instructions to generate purchase recommendations.

16. The computer-readable media as recited in claim 1, wherein the instructions use the at least one data set containing food preparation instructions to locate electronically retrievable coupons for product.

17. The computer-readable media as recited in claim 1, wherein the instructions retrieve the at least one data set containing food preparation instructions considering dietary needs of a user.

18. The computer-readable media as recited in claim 1, wherein the instructions automatically adjust data within the at least one data set containing food preparation instructions as a function of a location for the food preparation device.

19. The computer-readable media as recited in claim 1, wherein the instructions automatically adjust data within the at least one data set containing food preparation instructions as a function of an indicated, desired serving size.

20. The computer-readable media as recited in claim 1, wherein the instructions automatically adjust data within the at least one data set containing food preparation instructions as a function of an indicated, desired preparation result.
